(19) United States
(12) Patent Application Publication
(10) Pub. No.: US 2017/0021511 A1
(43) Pub. Date: Jan. 26, 2017

(54) Utility Knife

(71) Applicant: GOODLY-CH ENTERPRISE CO., LTD., Taichung City (TW)

(72) Inventor: Chin-Chang Chiu, Taichung City (TW)

(21) Appl. No.: 14/929,529

(22) Filed: Nov. 2, 2015

(30) Foreign Application Priority Data
Jul. 20, 2015 (TW) 104123415

(51) Int. Cl. B26B 5/00

(52) U.S. Cl. CPC B26B 5/003

(57) ABSTRACT

A utility knife includes a shell including first and second shell bodies releasably assembled together and disposed symmetrically in a Z-axis direction. A compartment is defined by inner walls of the first and second shell bodies. A channel extends from a distal end of the shell and disposed outside the compartment. A blade carrier assembly releasably engages with a blade and is movably received by the shell. The shell is configured such that the blade carrier assembly is movable to a first position in which the blade is in a retracted position and not extending out of the shell and, to a second position in which the blade is in an exposed position and extending out of the shell. The blade carrier assembly in the second position thereof is also guided by the channel.

### BACKGROUND OF THE INVENTION

1. Field of the Invention

The present invention relates to a utility knife and, particularly, to a utility knife assembled by hand and designed to be user-friendly and used safely.

2. Description of the Related Art

TW Pat. No. 357669 shows a utility knife deigned to be assembled in a quick manner. The utility knife includes a shell made up of two halves. A seat for receiving a blade is received by the two halves of the shell. The seat is movable on the shell. The two halves of the shell cooperate to form a channel and the seat is movably restrained on the channel. The seat is movable to a first position in which the blade extends out of the shell and to a second position in which the blade retracts inside the shell. One half of the shell includes an inner lateral side and a block formed on the lateral side defining a recess. Another half of the shell includes a lateral side and a hole through the lateral side and includes a lock mounted thereon. The lock forms a joining end adapted to insert through the hole and to selectively engage in the recess. The lock is movable on another half of the shell and is biased by a spring. The two halves of the shell can be assembled quickly and securely after the joining end of the lock engages in the recess, and the lock is in a first position. The two halves of the shell can be released from each other after the joining end of the lock disengages from the recess, and the lock is in a second position.

The spring can become fatigued or weak. As a result, the lock is unable to secure the halves of the shell together, and the shell is unable to retain the seat, the blade on the seat, and the lock.

The present invention is, therefore, intended to obviate or at least alleviate the problems encountered in the prior art.

### SUMMARY OF THE INVENTION

According to the present invention, a utility knife includes a shell including a first shell body and a second shell body relesably assembled together and disposed symmetrically in a Z-axis direction. A compartment is defined by inner walls of the first and second shell bodies. A channel extends from a distal end of the shell and disposed outside the compartment. A blade carrier assembly releasably engages with a blade and is movably received by the shell. The shell is configured such that the blade carrier assembly is movable to a first position in which the blade is in a retracted position and not extending out of the shell and, to a second position in which the blade is in an exposed position and extending out of the shell. The blade carrier assembly in the second position thereof is also guided by the channel.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a utility knife in accordance with the present invention.

FIG. 2 is an exploded perspective view of the utility knife of the present invention.

FIG. 3 is an exploded perspective view of the utility knife of the present invention, taken from a different angle than FIG. 2.

FIG. 4 is a cross-sectional view of the utility knife of the present invention shown in FIG. 1.

FIG. 5 is a cross-sectional view of the utility knife of the present invention taken along line 5-5 of FIG. 4.

FIG. 6 is a cross-sectional view of the utility knife of the present invention taken along line 6-6 of FIG. 4.

FIG. 7 is a cross-sectional view of the utility knife of the present invention, taken in the same cross-sectional plane as FIG. 4, but in a position in which a blade of the utility knife is exposed.

### DETAILED DESCRIPTION OF THE INVENTION

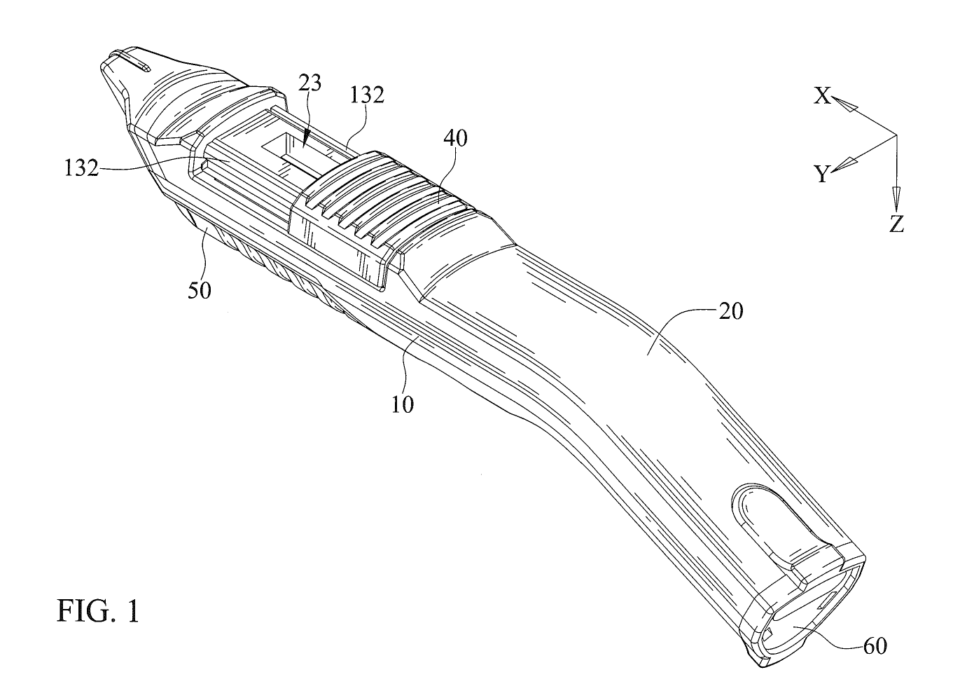

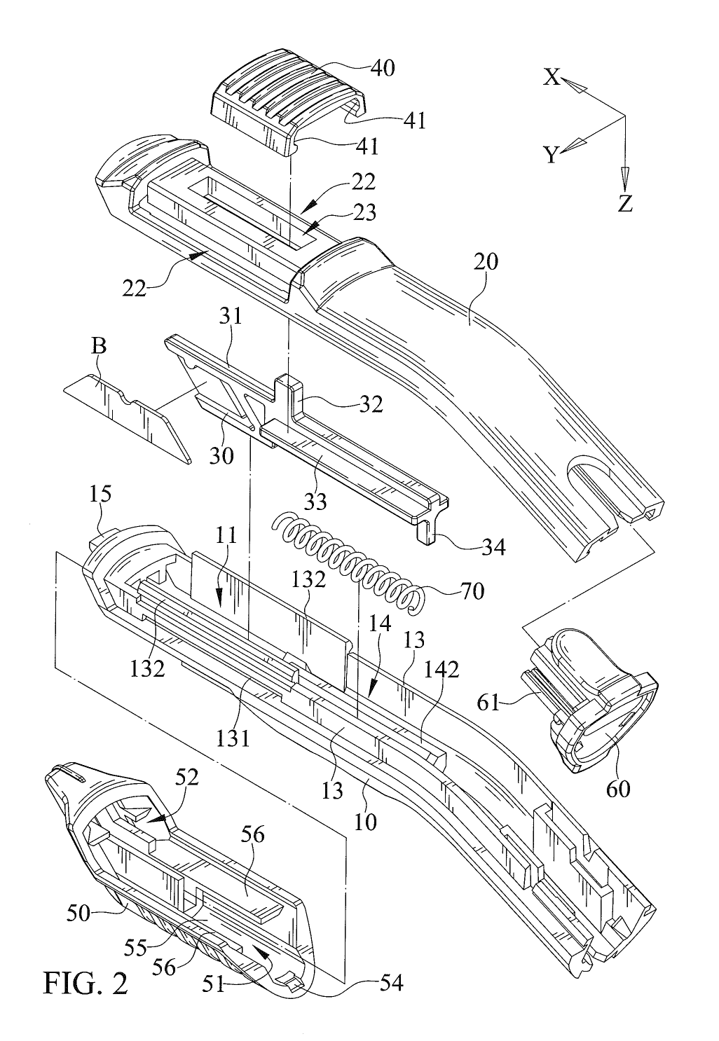

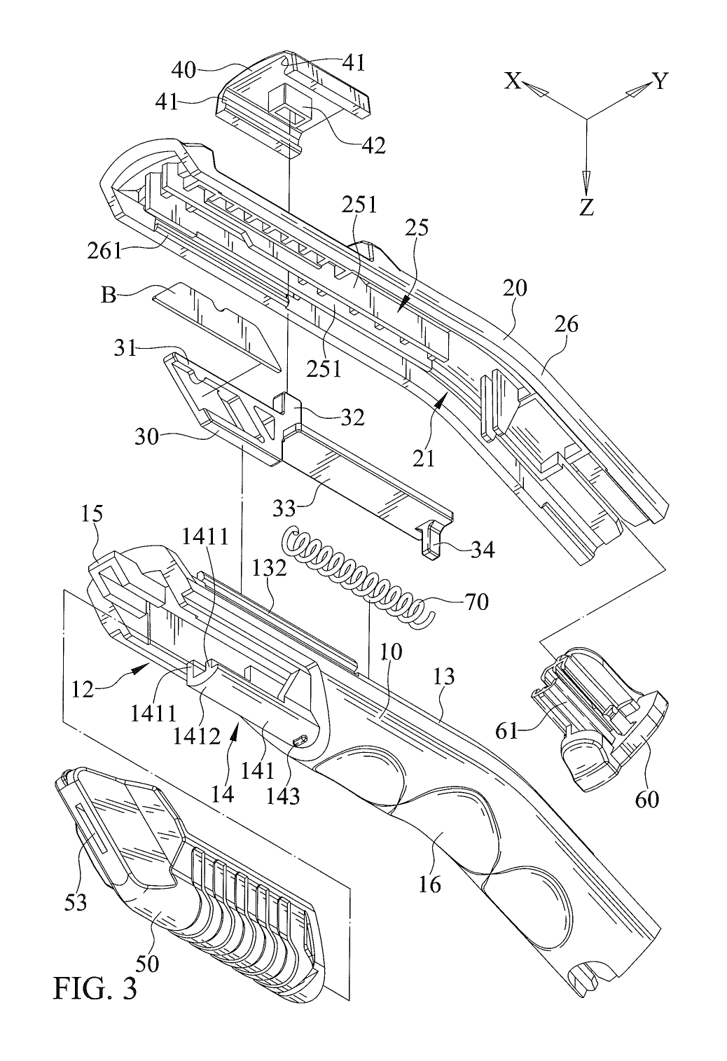

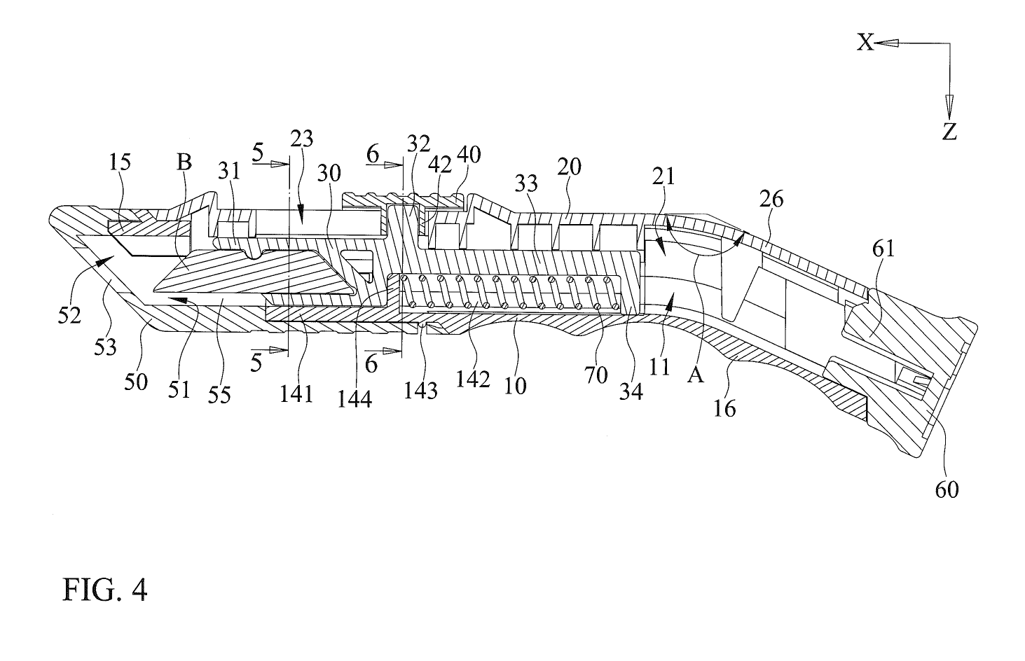

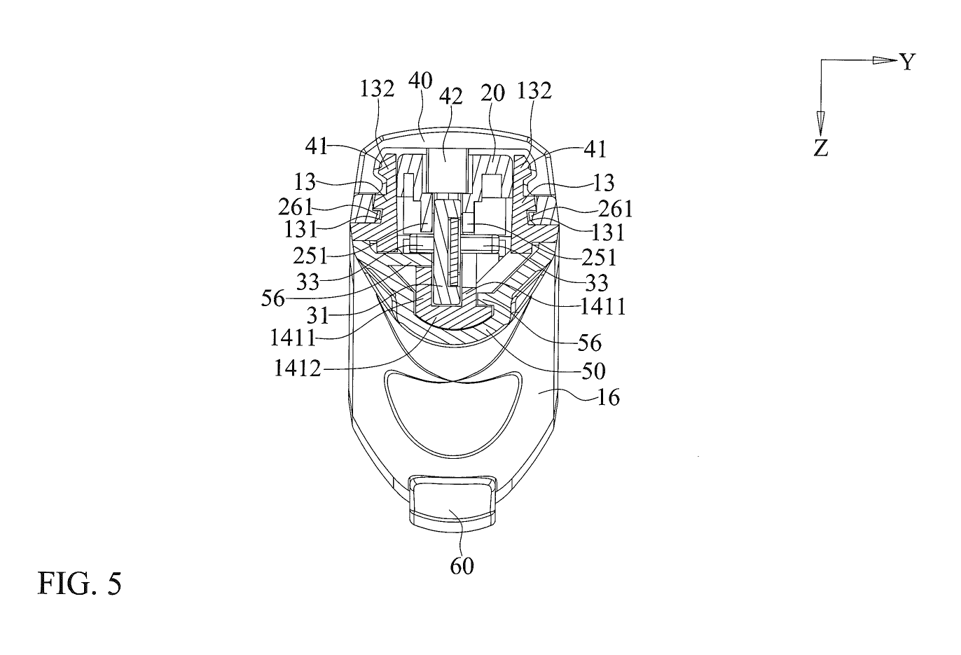

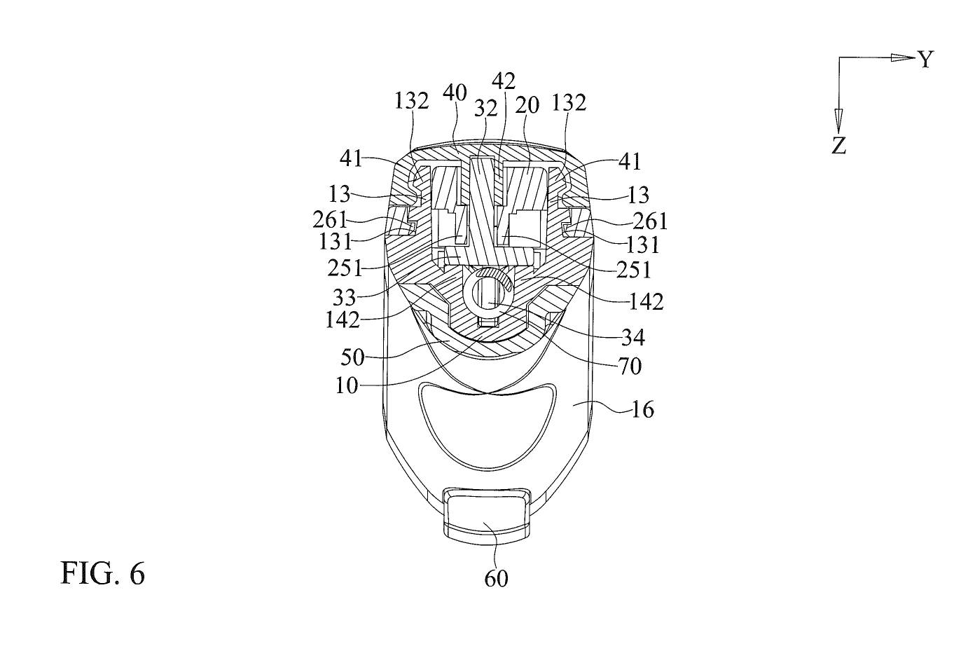

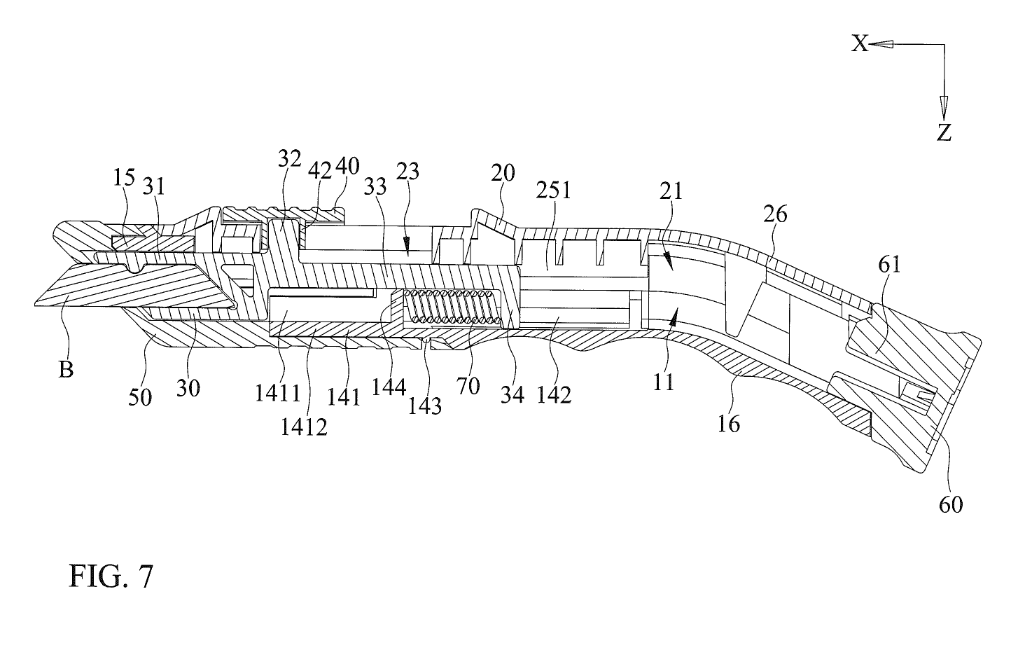

FIGS. 1 through 7 show a utility knife in accordance with the present invention.

A shell includes a first shell body 10 and a second shell body 20 releasably assembled together and disposed symmetrically in a Z-axis direction. The first shell body 10 includes a first mounting structure 13. The first mounting structure 13 is defined by an inner wall of the first shell body 10. The second shell body 20 includes a second mounting structure 26. The second mounting structure 26 is defined by an inner wall of the second shell body 20. The first and second mounting structures 13 and 26 engage together when the first and second shell bodies 10 and 20 are assembled together. The first and second mounting structures 13 and 26 are snap-fit designs. The first mounting structure 13 includes a first snap-fit design 131. The first snap-fit design 131 defines a recess. The second mounting structure 26 includes a second snap-fit design 261. The second snap-fit design 261 defines a hook. A compartment is defined by inner walls of the first and second shell bodies 10 and 20. A channel 15 extends from a distal end of the shell and is disposed outside the compartment. The first shell body 10 includes a first cavity 11. The first cavity 11 is defined by the inner wall of the first shell body 10. The second shell body 20 includes a second cavity 21. The second cavity 21 is defined by the inner wall of the second shell body 20. When the first and second shell bodies 10 and 20 are assembled together, the first and second cavities 11 and 21 cooperate to define the compartment. The shell is made of plastic.

A blade carrier assembly releasably engages with a blade B and is movably received by the shell. The blade carrier assembly includes a seat 30 disposed inside the shell. A groove 14 is defined by the inner wall of one of the shell bodies 10 and 20 and the seat 30 is movably received by the groove 14. The groove 14 is defined by the inner wall of the first shell body 10. The groove 14 and the channel 15 are aligned in an X-axis direction. The X-axis direction, as shown, is perpendicular to the Z-axis direction. The groove 14 includes one length extending outside the compartment and defining a first section 141 of the groove 14. The groove 14 includes another length extending inside the compartment and defining a second section 142 of the groove 14. The seat 30 defines a blade receiving area 31 for receiving the blade B. The blade receiving area 31 is at a first distal end of the seat 30. The blade receiving area 31 is received by the second section 142 of the groove 14. The blade B is designed to be of trapezoidal shape. The shape of the blade B defines a shorter base with a notch. The blade receiving area 31 defines a recess having a contour matching to a shape of the blade B and including three peripheral sides. The three peripheral sides of the blade receiving area 31 bound the shorter base and another two sides of the blade B. Another two sides of the blade B are a longer base and a leg extending between the shorter and longer bases. The shorter and longer bases are parallel to one another. The blade receiving area 31 has a protruded area received by the notch of the blade B. The seat 30 has a supporting edge 33 mounted on the groove 14. The groove 14 has two lateral sides bearing the supporting edge 33. The supporting edge 33 is disposed outside a space defined by the two lateral sides. The supporting edge 33 moves on the two lateral sides of the groove 14 when the blade carrier assembly is moved. Two lateral sides 251 of another groove 25 also abut the supporting edge 33. The groove 25 is defined by the inner wall of the other of first and second shell bodies 10 and 20. The supporting edge 33 is disposed outside a space defined by the two lateral sides of the groove 25. The supporting edge 33, therefore, includes one of two opposed sides abutting on the lateral sides of the groove 14 and another of the two opposed sides abutting on the lateral sides 251 of the groove 25, respectively. The blade carrier assembly is made of plastic. The blade B is specially made of ceramic material.

The blade carrier assembly further includes an input control 40 releasably mounted on the seat 30. The input control 40 is adapted to be used to operably move the seat 30. The input control 40 and the shell are releasably engaged with each other. The input control 40 is disposed outside the shell. The input control 40 and the shell are releasably engaged with each other in a manner that the input control 40 is prevented from disengaging from the shell inadvertently, with the input control 40 including at least one joining structure 41 and the shell including at least one retaining structure 132 releasably engaging with the at least one joining structure 41. The input control 40 includes an extension engaging and being movable on a rail defined by the shell. The at least one joining structure 41 engages and is movable on another rail 22 defined by the shell. The input control 40 is U shaped and includes two legs defining two joining structures 41. The rail is disposed between the two joining structures 41. Each retaining structure 132 extends in an upward direction from the inner wall of the first shell body 10 and has a first distal end fixed to the inner wall of the first shell body 10 and a second distal end defining a free end. Each joining structure 41 extends in a downward direction from the body extending between the joining structures 41 and has a first distal end fixed to the body and a second distal end defining a free end. The retaining and joining structures 132 and 41 are snap-fit designs. When the joining structures 41 and the retaining structures 132 are engaged with each other, each of the two retaining structures 132 and each of the joining structures 41 are disposed one on top of another. When disengaging the input control 40 from the shell, the engaged joining structure 41 and the retaining structure 132 can be moved laterally away from each other to disengage from each other. Then, the input control 40 can disengage from the shell. A slot 23 is defined by the shell and positioned between two lateral sides of the rail. The input control 40 and the seat 30 are releasably engaged with each other in a manner that the input control 40 is prevented from disengaging from the seat 30, with the seat 30 defining a first connecting end 32 and the input control 40 defining a second connecting end 42 releasable engaging with the first connecting end 32. The first and second connecting ends 32 and 42 are insertable into the slot 23. The first connecting end 32 defines a protrusion. The second connecting end 42 defines a hole. By connecting the first connecting end 32 to the second connecting end 42, the seat 30 and the input control 40 are connected. The slot 23 is positioned closer to one lateral side of the rail than the other. The second connecting end 42 is positioned closer to one of the joining structures 41 than the other. Accordingly, the input control 40 will not be installed on the shell in the wrong direction.

The shell is configured such that the blade carrier assembly is movable to a first position in which the blade is in a retracted position and not extending out of the shell and, to a second position in which the blade is in an exposed position and extending out of the shell. The blade carrier assembly in the second position thereof is also guided by the channel 15.

An opening 12 is defined by the shell and the shell includes a third shell body 50 assembled thereto and selectively disposed at a position enclosing the opening 12. The third shell body 50 is releasably assembled to the shell. The opening 12 communicates with the compartment. The third shell body 50 encloses the channel 15 as well as the first section 141 of the groove 14. The third shell body 50 includes a third cavity 51 and a fourth cavity 52 communicating with the third cavity 51. The third and fourth cavities 51 and 52 are located on opposite ends of the third shell body 50. When the first, second, and third shell bodies 10, 20, and 50 are assembled together, the channel 15 is disposed in the fourth cavity 52. The third shell body 50 and the first section 141 of the groove 14 are releasably engaged with each other in a manner that the third shell body 50 is prevented from disengaging from the groove 14 inadvertently, with the first section of the groove 14 includes a first constraining structure 143 and the third shell body 50 includes a second constraining structure 54 releasably engaging with the first constraining structure 143. One of the first and second constraining structures 143 and 54 defines a protrusion and the other of the first and second constraining structures 143 and 54 defines a cavity. The protrusion protrudes from the bottom side 1412 of the groove 14. The cavity extends through the third shell body 50. The second constraining structure 54 is adjacent to a second distal end of the third shell body 50. A passage 55 and a positioning ridge 56 are defined by an inner wall of the third shell body 50 and the first section 141 of the groove 14 is movably received by the passage 55 and positioned by the positioning ridge 56, with the first section 141 of the groove 14 including a bottom side 1412 on the passage 55, and with the first section 141 of the groove 14 including at least one lateral side 1411 extending upward from the bottom side 1412 and the positioning ridge 56 disposed on the at least one lateral side 1411. The first section 141 of the groove 14 includes two lateral sides 1411 and the bottom side 1412 extending between the two lateral sides 1411. Each of the two lateral sides 1411 extends in an upward direction from the bottom side 1412 and has a first distal end fixed to the bottom side and second distal end defining a free end. The seat 30 is movably received by a cavity, i.e. the fourth cavity 52, defined by the inner wall of the third shell body 50. The third shell body 50 includes a slit 53 extending therethrough and aligned with the blade B. The slit 53 is at a first distal end of the third shell body 50. The blade B is insertable through the slit 53. The blade B extends out of the slit 53 when the blade carrier assembly is at the second position thereof.

Another opening is defined by the shell and the shell includes a cap 60 assembled thereto and selectively disposed at a position enclosing the another opening, with the cap 60 forming prongs 61 releasably retaining on the shell. The cap 60 can be disengaged from the shell to allow the compartment to be open.

The blade carrier assembly is under a resilient force exerted by a resilient member 70. The resilient member 70 has an initial length. The resilient member 70 is compressed and the initial length is reduced when the blade carrier assembly is in the first position thereof. The resilient member 70 is uncompressed and the initial length is restored when the blade carrier assembly is in the second position thereof. The resilient member 70 is disposed in the groove 14 and between a retaining end 34 defined by the seat 30 and a side defined by the groove 14. The retaining end 34 defines a protrusion. The retaining end 34 and the first connecting end 32 extend in opposite directions. The retaining end 34 is at a second distal end of the seat 30. The retaining end 34 is received by the groove 14. The side defined by the groove 14 defines a partition wall 144, and the resilient member 70 is disposed between the retaining end 34 and the partition wall 144. The partition wall 144 partitions the first and second sections 141 and 142 of the groove 14.

The blade receiving area 31 is fully exposed by dissembling the third shell body 50 from the shell and moving the blade carrier assembly to the second position thereof. Accordingly, the blade B can be fit easily and quickly to the seat 30 of the blade carrier assembly.

Furthermore, the utility knife has ergonomic designs in that it has a shape having a length in an X-direction, with the length including a first length measuring from a first distal end to an intermediate end of the utility knife and a second length measuring from the intermediate end to the second distal end of the utility knife. The first and second lengths include an obtuse included angle A. Also, at least one finger indentation 16 is formed on the shell for a comfortable, secure grip of the utility knife. The at least one finger indentation 16 is positioned on a lower side of the shell, whereas the input control 40 is positioned on an upper side of the shell.

In view of the forgoing, the utility knife is adapted to be assembled by hand and is designed to be user-friendly and used safely.

The foregoing is merely illustrative of the principles of this invention and various modifications can be made by those skilled in the art without departing from the scope and spirit of the invention.

What is claimed is:

1. A utility knife comprising:
a shell including a first shell body and a second shell body releasably assembled together and disposed symmetrically in a Z-axis direction;
a compartment defined by inner walls of the first and second shell bodies;
a channel extending from a distal end of the shell and disposed outside the compartment;
a blade carrier assembly releasably engaging with a blade and movably received by the shell;
wherein the shell is configured such that the blade carrier assembly is movable to a first position in which the blade is in a retracted position and not extending out of the shell and, to a second position in which the blade is in an exposed position and extending out of the shell; and
wherein the blade carrier assembly in the second position thereof is also guided by the channel.

2. The utility knife as claimed in claim 1, wherein the blade carrier assembly includes a seat disposed inside the shell and an input control releasably mounted on the seat and disposed outside of the shell, and wherein the seat defines a blade receiving area for receiving the blade.

3. The utility knife as claimed in claim 2, wherein the blade is designed to be of trapezoidal shape, wherein the shape of the blade defines a shorter base with a notch, wherein the blade receiving area defines a recess having a contour matching to a shape of the blade and including three peripheral sides, wherein the three peripheral sides of the blade receiving area bound the shorter base and another two sides of the blade, and wherein the blade receiving area has a protruded area received by the notch of the blade.

4. The utility knife as claimed in claim 2 further comprising a groove defined by the inner wall of one of the shell bodies and the seat is movably received by the groove.

5. The utility knife as claimed in claim 4, wherein the blade carrier assembly is under a resilient force exerted by a resilient member, wherein the resilient member has an initial length, wherein the resilient member is compressed and the initial length is reduced when the blade carrier assembly is in the first position thereof, and wherein the resilient member is uncompressed and the initial length is restored when the blade carrier assembly is in the second position thereof.

6. The utility knife as claimed in claim 5, wherein the resilient member is disposed in the groove and between a retaining end defined by the seat and a side defined by the groove.

7. The utility knife as claimed in claim 6, wherein the groove includes one length extending outside the compartment and defining a first section of the groove, wherein the groove includes another length extending inside the compartment and defining a second section of the groove, and wherein the blade receiving area is received by the second section of the groove.

8. The utility knife as claimed in claim 4, wherein the seat has a supporting edge mounted on the groove, wherein the groove has two lateral sides bearing the supporting edge, wherein the supporting edge is disposed outside a space defined by the two lateral sides, and wherein the supporting edge moves on the two lateral sides of the groove when the blade carrier assembly is moved.

9. The utility knife as claimed in claim 2, wherein the input control and the shell are releasably engaged with each other in a manner that the input control is prevented from disengaging from the shell inadvertently, with the input control including at least one joining structure and the shell including at least one retaining structure releasably engaging with the at least one joining structure, and wherein the input control includes an extension engaging and being movable on a rail defined by the shell.

10. The utility knife as claimed in claim 9, wherein the input control is U shaped and includes two legs defining two joining structures, and wherein the rail is disposed between the two joining structures.

11. The utility knife as claimed in claim 9, wherein the at least one joining structure engages and is movable on another rail defined by the shell.

12. The utility knife as claimed in claim 9 further comprising a slot defined by the shell and positioned between two lateral sides of the rail, wherein the input control and the seat are releasably engaged with each other in a manner that the input control is prevented from disengaging from the seat, with the seat defining a first connecting end and the input control defining a second connecting end releasable engaging with the first connecting end, and wherein the first and second connecting ends are insertable into the slot.

13. The utility knife as claimed in claim 12, wherein the slot is positioned closer to one lateral side of the rail than the other, and wherein the second connecting end is positioned closer to one of the joining structures than the other.

14. The utility knife as claimed in claim 2 further comprising an opening defined by the shell, wherein the shell includes a third shell body assembled thereto and selectively disposed at a position enclosing the opening, wherein the third shell body encloses the channel, wherein the seat is movably received by a cavity defined by an inner wall of the third shell body, wherein the third shell body includes a slit extending therethrough and aligned with the blade, wherein the blade is insertable through the slit, and wherein the blade extends out of the slit when the blade carrier assembly is in the second position thereof.

15. The utility knife as claimed in claim 7 further comprising an opening defined by the shell and the shell includes a third shell body releasably assembled thereto and selectively disposed at a position enclosing the opening, wherein the third shell body encloses the channel as well as the first section of the groove, wherein the seat is movably received by a cavity defined by an inner wall of the third shell body, wherein the third shell body includes a slit extending therethrough and aligned with the blade, wherein the blade is insertable through the slit, and wherein the blade extends out of the slit when the blade carrier assembly is in the second position thereof.

16. The utility knife as claimed in claim 15, wherein the third shell body and the first section of the groove are releasably engaged with each other in a manner that the third shell body is prevented from disengaging from the groove inadvertently, with the first section of the groove includes a first constraining structure and the third shell body includes a second constraining structure releasably engaging with the first constraining structure.

17. The utility knife as claimed in claim 15 further comprising a passage and a positioning ridge defined by the inner wall of the third shell body and the first section of the groove is movably received by the passage and positioned by the positioning ridge, with the first section of the groove including a bottom side on the passage, and with the first section of the groove including at least one lateral side extending upward from the bottom side and the positioning ridge disposed on the at least one lateral side.

18. The utility knife as claimed in claim 14 further comprising another opening defined by the shell and the shell includes a cap assembled thereto and selectively disposed at a position enclosing the another opening, with the cap forming prongs releasably retaining on the shell.

19. The utility knife as claimed in claim 1, with a shape of the utility knife having a length in an X-direction, with the length including a first length measuring from a first distal end to an intermediate end of the utility knife and a second length measuring from the intermediate end to the second distal end of the utility knife, and wherein the first and second lengths include an obtuse included angle.

20. The utility knife as claimed in claim 1 further comprising at least one finger indentation on the shell for a comfortable, secure grip of the utility knife.
